(19) United States
(12) Patent Application Publication
(10) Pub. No.: US 2017/0372664 A1
(43) Pub. Date: Dec. 28, 2017

(54) Gate Driver On Array Circuit and Scanning Method Thereof, Display Panel and Display Device

(71) Applicant: BOE Technology Group Co., Ltd., Beijing (CN)

(72) Inventors: Min He, Beijing (CN); Guangcai Yuan, Beijing (CN)

(73) Assignee: BOE Technology Group Co., Ltd., Beijing (CN)

(21) Appl. No.: 15/538,035

(22) PCT Filed: Sep. 27, 2016
(86) PCT No.: PCT/CN2016/100356

§ 371 Date: Jun. 20, 2017

(30) Foreign Application Priority Data
Dec. 31, 2015 (CN) 201511030529.9

(51) Int. Cl. G09G 3/34; G09G 3/02; G09G 3/20

(52) U.S. Cl. CPC G09G 3/342; G09G 3/2085; G09G 3/02; G09G 2310/0267; G09G 2300/0408

(57) ABSTRACT

A GOA circuit and scanning method thereof, display panel and display device are provided. The GOA circuit includes: a plurality of GOA units (1−n+2K) connected in cascades, signal output terminal of each GOA unit is connected to one row of gate lines, signal output terminal of n-th row of GOA unit is connected to signal input terminal of (n+k)-th row of GOA unit, and output terminal of the (n+k)-th row of the GOA unit is connected to signal reset terminal of the n-th row of the GOA unit and signal input terminal of of (n+2k)-th row GOA unit; the GOA circuit further comprises: gating unit (204) connected to first to k-th rows of GOA units, which controls the GOA circuit to output scanning signal from first group to k-th group of gate lines sequentially; in x-th group, the GOA circuit outputs scanning signal from x-th row to (m×k+x)-th row sequentially.

### TECHNICAL FIELD

The present disclosure relates to a GOA circuit, a scanning method of the GOA circuit, a display panel and a display device.

### BACKGROUND

In recent years, development of displays presents a trend of high integrity and low cost. A very important technique is implementation of productivity of the gate driver on array technique. A gate switching circuit is integrated on an array substrate of a display panel by utilizing the GOA technique, so that the gate driving integrated circuit part can be omitted, so as to reduce the product cost from the two aspects of material cost and manufacturing process. Such gate switching circuit which is integrated on the array substrate by utilizing the GOA technique is also called as a GOA circuit or a shift register circuit.

The GOA circuit comprises several GOA units, each of which comprises several thin film transistors (TFT, hereinafter referred to as transistor), wherein each GOA unit is corresponding to one row of gate lines. In particular, an output terminal of each GOA unit is connected to one row of gate lines. Since the GOA circuit needs a large-scale integrated circuit (IC) to be implemented, how to control the amount of usage of IC while guaranteeing performance of the GOA becomes a development direction of the GOA circuit.

A known GOA circuit is generally implemented by a plurality of GOA units connected in cascades, and usually an output of a next stage of GOA unit is triggered by an output signal of a previous stage of GOA circuit. However, as display resolution is raised, it requires more and more GOA units connected in cascades. Therefore, apparent attenuation would occur to the output signal in the delivery process. Therefore, in the GOA circuit, the later a GOA unit is located in the cascade connection, the more the GOA unit would be influenced by an output signal of a previous stage of GOA unit, thereby finally affecting the display effect.

### SUMMARY

There are provided in embodiments of the present disclosure a GOA circuit, a scanning method of the GOA circuit, a display panel and a display device, which are used to solve the problem of apparent attenuation of output signals caused by too many cascade connections of GOAs in a conventional GOA circuit.

According to a first aspect of the present disclosure, there is provided a GOA circuit, comprising:

a plurality of rows of GOA units connected in cascades, wherein a signal output terminal of each row of GOA unit is connected to one gate line;

wherein a signal output terminal of a n-th row of GOA unit is connected to a signal input terminal of a (n+k)-th row of GOA unit, and an output terminal of the (n+k)-th row of GOA unit is connected to a signal reset terminal of the n-th row of GOA unit and a signal input terminal of a (n+2k)-th row of GOA unit;

the GOA unit further comprises a gating unit connected to first to k-th rows of GOA units;

wherein the gating unit controls the GOA circuit to output a scanning signal from a first group to a k-th group of gate lines sequentially; and in a x-th group, the GOA circuit outputs a scanning signal from a x-th row to a (m×k+x)-th row, 1≦x≦k.

Optionally, in two adjacent groups of gate lines, the gating unit is configured to trigger a GOA unit corresponding to a first row of gate lines of a next group of gate lines to output a scanning signal after it is detected that a GOA unit corresponding to a last row of gate lines of a previous group of gate lines outputs a scanning signal.

Optionally, the gating unit comprises a first gating sub-unit and a second gating sub-unit;

wherein the first gating sub-unit is connected to a GOA unit of a first row of gate lines of an odd-numbered group of gate lines; and the second gating sub-unit is connected to a GOA unit of a first row of gate lines of an even-numbered group of gate lines.

Optionally, in two adjacent odd-numbered groups of gate lines, the first gating sub-unit is configured to trigger a GOA unit corresponding to a first row of gate lines of a next odd-numbered group of gate lines to output a scanning signal after it is detected that a GOA unit corresponding to a last row of gate lines of a previous odd-numbered group of gate lines outputs a scanning signal; and

in two adjacent even-numbered groups of gate lines, the second gating sub-unit is configured to trigger a GOA unit corresponding to a first row of gate lines of a next even-numbered group of gate lines to output a scanning signal after it is detected that a GOA unit corresponding to a last row of gate lines of a previous even-numbered group of gate lines outputs a scanning signal.

According to a second aspect of the present disclosure, there is provided a scanning method of the GOA circuit as presented in the first aspect, comprising:

controlling the GOA circuit to output a scanning signal from a first group to a k-th group of gate lines sequentially;

in a x-th group, outputting a scanning signal from a x-th row to a (m×k+x)-th row sequentially by the GOA circuit.

Optionally, the controlling the GOA circuit to output a scanning signal from a first group to a k-th group of gate lines sequentially comprises:

in two adjacent groups of gate lines, triggering a GOA unit corresponding to a first row of gate lines of a next group of gate lines to output a scanning signal after it is detected that a GOA unit corresponding to a last row of gate lines of a previous group of gate lines output a scanning signal.

Optionally, the controlling the GOA circuit to output a scanning signal from a first group to a k-th group of gate lines sequentially comprises:

in two adjacent odd-numbered groups of gate lines, triggering a GOA unit corresponding to a first row of gate lines of a next odd-numbered group of gate lines to output a scanning signal after it is detected that a GOA unit corresponding to a last row of gate lines of a previous odd-numbered group of gate lines outputs a scanning signal; and

in two adjacent even-numbered groups of gate lines, triggering a GOA unit corresponding to a first row of gate lines of a next even-numbered group of gate lines to output a scanning signal after it is detected that a GOA unit corresponding to a last row of gate lines of a previous even-numbered group of gate lines outputs a scanning signal.

According to a third aspect of the present disclosure, there is provided a display panel of the GOA circuit as presented in the first aspect.

According to a fourth aspect of the present disclosure, there is provided a display device of the display panel as presented in the third aspect.

The GOA circuit, the scanning method of the GOA circuit, the display panel and the display device provided in the present disclosure perform cascade connection within a group after grouping the GOA units in the GOA circuit, and trigger each group of GOA units through the gating unit sequentially to output a scanning signal to a gate line, which reduces the number of stages of the GOA units connected in cascades, reduces signal attenuation, and solves the problem of apparent attenuation of output signals caused by too many cascade connections of GOAs in a conventional GOA circuit.

### BRIEF DESCRIPTION OF THE DRAWINGS

FIG. 1 is a structure schematic diagram of a display panel provided in an embodiment of the present disclosure;

FIG. 2 is a structure schematic diagram of a GOA circuit provided in an embodiment of the present disclosure;

FIG. 3 is an operation timing diagram of a GOA circuit provided in an embodiment of the present disclosure;

FIG. 4 is a structure schematic diagram of a GOA circuit provided in another embodiment of the present disclosure; and

FIG. 5 is a timing diagram of a GOA circuit provided in another embodiment of the present disclosure.

### DETAILED DESCRIPTION

Technical solutions in embodiments of the present disclosure will be described clearly and completely by combining with figures. Obviously, the embodiments described below are just a part of embodiments of the present disclosure, but not all the embodiments of the present disclosure. Based on principles described in the specification of the present disclosure, those ordinary skilled in the art can obtain other embodiments without making any inventive labor.

The present disclosure divides the GOA units directly connected in cascades in series in the original GOA circuit into k groups, and connects the GOA units within the group in cascades, such that a signal output terminal of a previous GOA unit within the group is connected to a signal input terminal of a next GOA unit within the group. Additionally, a gating unit is added and configured to gate individual groups respectively. During operation, the gating unit triggers a first GOA unit within a first group to output a scanning signal by using a frame start (STV) signal, and inputs a signal output by a previous GOA unit to a signal input terminal of a next GOA unit to trigger the next GOA unit. By analogy, output of all GOA units within the first group is triggered row by row. After the output of the first group ends up, the gating unit triggers the first GOA unit in the second group to output the scanning signal through the STV signal. After that, the processing mode of the respective GOA units in the first group is performed, so that triggering all the GOA units to output the scanning signal is realized.

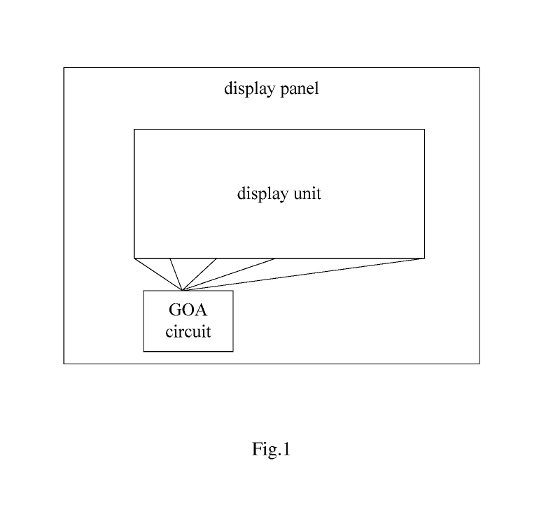

FIG. 1 shows a structure schematic diagram of a display panel provided in an embodiment of the present disclosure.

As shown in FIG. 1, the display panel comprises a display unit and a GOA circuit. The GOA circuit is used to drive the displaying of the display unit.

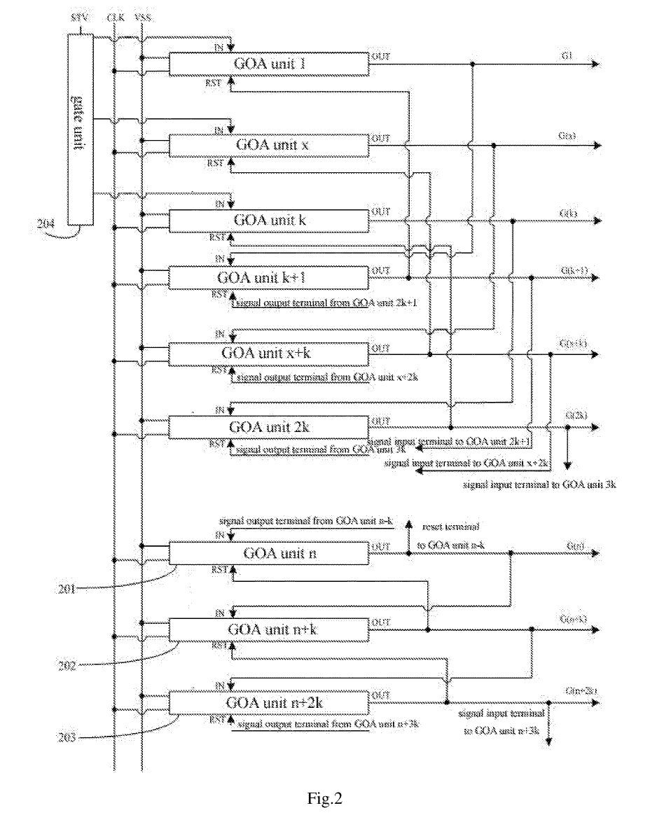

FIG. 2 shows a structure schematic diagram of a GOA circuit provided in an embodiment of the present disclosure. The GOA circuit is applied to the display panel. As shown in FIG. 2, the GOA circuit comprises a plurality of GOA units connected in cascades.

Exemplarily, each GOA unit has a signal output terminal OUT, a signal input terminal IN and a reset terminal RST. Herein, the signal output terminal OUT is connected to one row of gate lines G1-G(n+2k), and is used to output a scanning signal, the signal input terminal IN is used to initiate the GOA unit to start outputting the scanning signal, and the reset terminal RST is used to make the GOA unit stop outputting the scanning signal.

For example, referring to FIG. 2, the plurality of GOA units are divided into k groups, and the GOA units spacing k rows are divided into one group. In other words, the 1-st, (1+k)-th, (1+2k)-th, . . . , row of GOA units are taken as a first group, a 2-nd, (2+k)-th, (2+2k)-th, . . . , row of GOA units are taken as a second group, and so on and so forth, until a k-th, 2k-th, 3k-th, . . . , row of GOA units are taken as a k-th group. Herein, a signal output terminal OUT of a n-th row of GOA unit 201 is connected to an signal input terminal IN of a (n+k)-th row of GOA unit 202, and a signal output terminal OUT of the (n+k)-th row of GOA unit 202 is connected to a signal reset terminal RST of the n-th row of GOA unit 201 and a signal input terminal IN of a (n+2k)-th row of GOA unit 203, and so on and so forth, so as to realize the cascade connection of GOA units within one group. Therefore, the first GOA units of the first to k-th group are first to k-th rows of GOA units, and other GOA units within respective groups are connected in cascades subsequent to signal output terminals of the first row of GOA unit of respective groups respectively, where k and n are positive integers greater than or equal to 1.

As shown in FIG. 2, the GOA circuit further comprises a gating unit 204. The gating unit 204 is connected to the first GOA unit in the respective groups. That is to say, the gating unit is connected to signal input terminals IN of the first to k-th rows of GOA units. It is equivalent to control all the GOA units through the gating unit 204 because other GOA units within respective groups are connected in cascades subsequent to the first GOA unit of respective groups sequentially.

The gating unit 204 controls the GOA circuit to output the scanning signal from the first group to the k-th group of gate lines sequentially. In the x-th group, the GOA circuit outputs the scanning signal from a x-th row to a (m×k+x)-th row sequentially. That is to say, the gating unit 204 gates firstly one group, and then traverse the GOA units within this group sequentially to output the scanning signal sequentially, and after all the GOA units within this group output the scanning signal, a next group is selected, and so on and so forth, so as to finally realize controlling all the GOA units to output the scanning signal, where 1≦x≦m is a positive integer greater than or equal to 1.

Optionally, the gating unit 204 can be connected to the STV signal input terminal, and can drive the first row of GOA units of respective groups by a frame start signal input from a STV signal input terminal.

In the GOA circuit provided in the embodiments of the present disclosure, the GOA units in the GOA circuit are grouped and then connected in cascades within a group, and each group of GOA units are triggered by the gating unit 204 sequentially to output the scanning signal to the gate line, thereby the number of stages of the GOA units connected in cascades is reduced, the signal attenuation is decreased, and the problem of apparent attenuation of output signals caused by too many cascade connections of GOAs in a conventional GOA circuit.

Exemplarily, in two adjacent groups of gate lines, the gating unit 204 as shown in FIG. 2 can be further used to trigger a GOA unit corresponding to a first row of gate lines of a next group of gate lines to output the scanning signal after it is detected that a GOA unit corresponding to a last row of gate lines of a previous group of gate lines outputs the scanning signal.

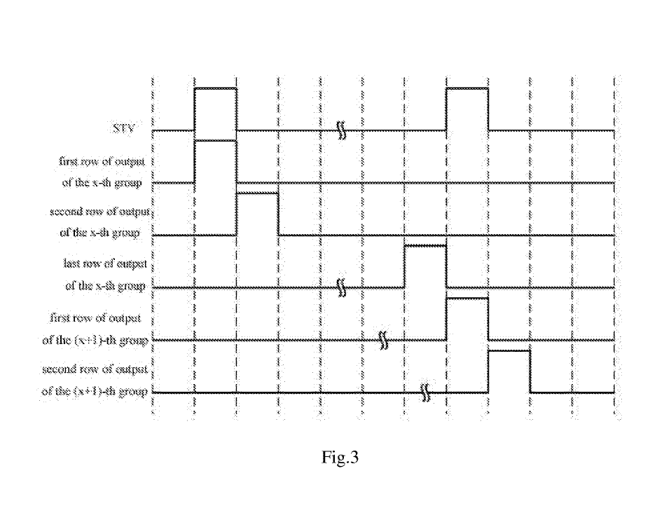

FIG. 3 shows an operation timing diagram of a GOA circuit provided in an embodiment of the present disclosure.

As shown in FIG. 3, the STV signal triggers a first row of GOA unit of an x-th group to output the scanning signal, and the output of the first row of GOA units of the x-th group triggers a second row of GOA unit of the x-th group to output the scanning signal, until a last row of GOA units of the x-group outputs the scanning signal. After the gating unit 204 detects that the last row of GOA unit of the x-th group outputs the scanning signal, a (x+1)-th group is gated, and a first row of GOA units of the (x+1)-th group is triggered by the STV signal to outputs the scanning signal, and so on and so forth.

Additionally, FIG. 2 also shows a group of system clock signals CLK and at least one level signal VSS connected to the GOA unit. It shall be understood that it is just an example herein. As well known by those skilled in the art, the GOA unit can further be driven by more than two system clocks and a plurality of level signals.

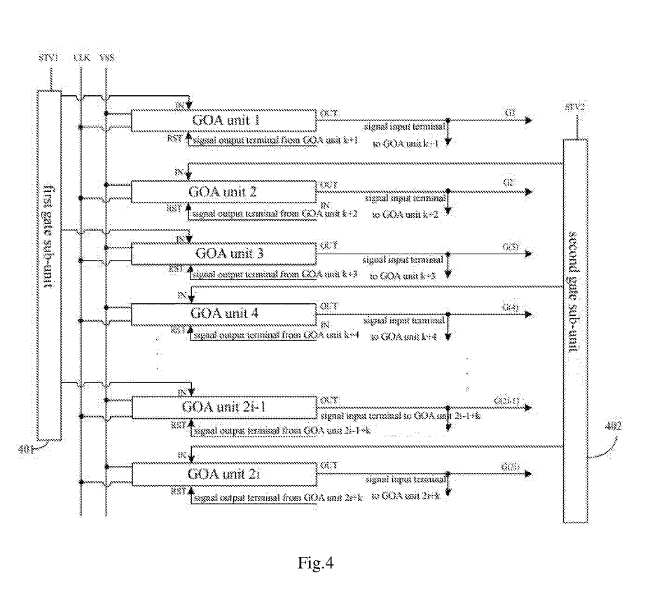

FIG. 4 shows a structure schematic diagram of another GOA circuit provided in an embodiment of the present disclosure. As shown in FIG. 4, following improvements are made to the GOA circuit on the basis of the GOA circuit as shown in FIG. 2:

the gating unit 204 comprises a first gating sub-unit 401 and a second gating sub-unit 402; and

the first gating sub-unit 401 is connected to a signal input terminal IN of a GOA unit of a first row of gate lines of an odd-numbered group of gate lines; the second gating sub-unit 402 is connected to a signal input terminal IN of a GOA unit of a first row of gate lines of an even-numbered group of gate lines. That is to say, odd-numbered groups in all k groups of GOA unit are managed by the first gating sub-unit 401, and even-numbered groups in all k groups of GOA unit are managed by the second gating sub-unit 402. Herein, the k groups are the k groups in the GOA circuit as shown in FIG. 2.

At this time, the gating unit 204 can be connected to two STV signal input terminals, that is, the first gating sub-unit 401 is connected to STV1, and the second gating sub-unit 402 is connected to STV2. Furthermore, the first gating sub-unit 401 drives the first row of GOA units of the even-numbered groups through a STV1 signal, and the second gating sub-unit 402 drives the first row of GOA unit of the even-numbered groups through a STV2 signal.

In particular, as shown in FIG. 4, the first gating sub-unit 401 is connected to a first GOA unit of a (2i−1)-th group, and the second gating sub-unit 402 is connected to a first GOA unit of a 2i-th group, where i satisfies 1≦2i−1≦k, 1≦2i≦k, and i is an integer.

Further, in two adjacent odd-numbered groups of gate lines, the first gating sub-unit 401 is configured to trigger a GOA unit corresponding to a first row of gate lines of a next odd-numbered group of gate lines to output the scanning signal after it is detected that a GOA unit corresponding to a last row of gate lines of a previous odd-numbered group of gate lines outputs the scanning signal.

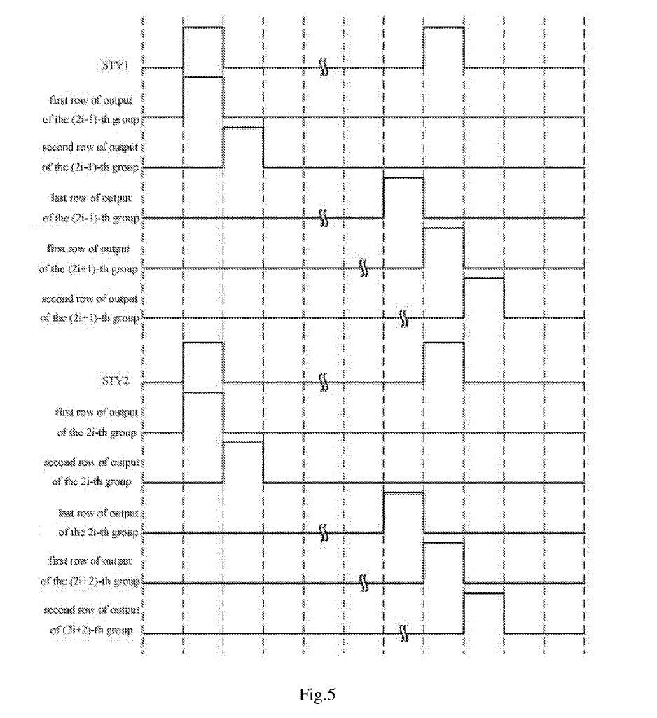

FIG. 5 shows a timing diagram of a GOA circuit provided in another embodiment of the present disclosure.

In particular, as shown in FIG. 5, the STV1 signal triggers the first row of GOA units of the (2i−1)-th group to output the scanning signal, and the output of the first row of GOA units of the (2i−1)-th group triggers the second row of GOA unit of the (2i−1)-th group to output the scanning signal, until the last row of GOA units of the (2i−1)-th group outputs the scanning signal. After the first gating sub-unit 401 detects that the last row of GOA units of the (2i−1)-th group outputs the scanning signal, the (2i+1)-th group is gated, and the first row of GOA units of the (2i+1)-th group is triggered by using the STV1 signal to output the scanning signals, and so on and so forth, where i satisfies 1≦2i−1≦k, 1≦2i≦k, and i is an integer.

In addition, in two adjacent even-numbered groups of gate lines, the second gating sub-unit 402 is configured to trigger a GOA unit corresponding to a first row of gate lines of a next even-numbered group of gate lines to output a scanning signal after it is detected that a GOA unit corresponding to a last row of gate lines of a previous even-numbered group of gate lines outputs the scanning signal.

In particular, as shown in FIG. 5, the STV2 signal triggers the first row of GOA units of the 2i-th group to output the scanning signal, the output of the first row of GOA unit of the 2i-th group triggers the second row of GOA unit of the 2i-th group to output the scanning signal, until the last row of GOA unit of the 2i-th group outputs the scanning signal. After the first gating sub-unit 401 detects that the last row of GOA unit of the 2i-th group outputs the scanning signal, the (2i+2)-th group is gated, and the first row of GOA unit of the (2i+2)-th group is triggered by using the STV2 signal to output the scanning signal, and so on and so forth, where i satisfies 1≦2i−1≦k, 1≦2i≦k, and i is an integer.

In the GOA circuit provided in the embodiments of the present disclosure, the GOA units in the GOA circuit are grouped and then connected in cascades within a group, and each group of GOA units are triggered through the gating unit sequentially to output the scanning signal to the gate line, which reduces the number of stages of the GOA units connected in cascades, decreases signal attenuation, and can solve the problem of apparent attenuation of output signals caused by too many cascade connections of GOAs in a conventional GOA circuit. In addition, by re-dividing the grouped GOA units into an odd-numbered group and an even-numbered group, and by driving the odd-numbered group and the even-numbered group respectively through two gating sub-units, the odd-numbered group and the even-numbered group can be driven simultaneously, which raises a refresh frequency of each frame display picture in double. It could be understood that the embodiment of the present disclosure is not limited to that the grouped GOA unit is divided into only the two groups of the odd-numbered group and the even-numbered group, and is driven respectively by adopting only two gating sub-units, and can also comprise being divided into a plurality of groups and adopting a plurality of gating sub-units to drive.

An embodiment of the present disclosure further provides a scanning method of the GOA circuit as described in FIGS. 2 and 5, comprising:

controlling the GOA circuit to output a scanning signal from first to k-th groups of gate lines sequentially.

Optionally, in two adjacent groups of gate lines, a GOA unit corresponding to a first row of gate lines of a next group of gate lines is triggered to output a scanning signal after it is detected that a GOA unit corresponding to a last row of gate lines of a previous group of gate lines outputs the scanning signal.

In addition, optionally, in two adjacent odd-numbered groups of gate lines, a GOA unit corresponding to a first row of gate lines of a next odd-numbered group of gate lines is triggered to output a scanning signal after it is detected that a GOA unit corresponding to a last row of gate lines of a previous odd-numbered group of gate lines outputs the scanning signal;

In two adjacent even-numbered groups of gate lines, a GOA unit corresponding to a first row of gate lines of a next even-numbered group of gate lines is triggered to output a scanning signal after it is detected that a GOA unit corresponding to a last row of gate lines of a previous even-numbered group of gate lines outputs the scanning signal.

In addition, in a x-th group, the GOA circuit outputs a scanning signal from a x-th row to a (m×k+x)-th row sequentially, where 1≦x≦k, m is a positive integer greater than or equal to 1.

In scanning method of the GOA circuit provided in the embodiment of the present disclosure, the GOA units in the GOA circuit are grouped and then connected in cascades within a group, and each group of GOA units are triggered through the gating unit sequentially to output the scanning signal to the gate line, which reduces the number of stages of the GOA units connected in cascades, decreases signal attenuation, and can solve the problem of apparent attenuation of output signals caused by too many cascade connections of GOAs in a conventional GOA circuit.

An embodiment of the present disclosure further provides a display device, which adopts the display panel as described above. The display device herein can be any product or means having the display function such as an electronic paper, a mobile phone, a tablet computer, a television set, a display, a notebook computer, a digital photo frame, a navigator, etc.

The above descriptions are just specific implementations of the present disclosure, but the protection scope of the present disclosure is not limited thereto. Any alternation or replacement that can be conceived easily by those skilled in the art who are familiar with the technical field within the technical scope disclosed in the present disclosure shall be covered into the protection scope of the present disclosure. Therefore, the protection scope of the present disclosure shall be subjected to the protection scope of the claims.

The present application claims the priority of a Chinese patent application No. 201511030529.9 filed on Dec. 31, 2015. Herein, the content disclosed by the Chinese patent application is incorporated in full by reference as a part of the present disclosure.

1. A GOA circuit, comprising: a plurality of GOA units connected in cascades, a signal output terminal of each GOA unit being connected to one row of gate lines, a signal output terminal of a n-th row of GOA unit being connected to a signal input terminal of a (n+k)-th row of GOA unit, and a signal output terminal of the (n+k)-th row of GOA unit being connected to a signal reset terminal of the n-th row of GOA unit and a signal input terminal of a (n+2k)-th row of GOA unit;
the GOA circuit further comprising: a gating unit connected to first to k-th rows of GOA units;
wherein the gating unit controls the GOA circuit to output a scanning signal from a first group to a k-th group of gate lines sequentially; and in a x-th group, the GOA circuit outputs a scanning signal from a x-th row to a (m×k+x)-th row, 1≦x≦k.

2. The GOA circuit according to claim 1, wherein
in two adjacent groups of gate lines, the gating unit is configured to trigger a GOA unit corresponding to a first row of gate lines of a next group of gate lines to output a scanning signal after it is detected that a GOA unit corresponding to a last row of gate lines of a previous group of gate lines outputs a scanning signal.

3. The GOA circuit according to claim 1, wherein the gating unit comprises a first gating sub-unit and a second gating sub-unit;
the first gating sub-unit is connected to a GOA unit of a first row of gate lines of an odd-numbered group of gate lines; and
the second gating sub-unit is connected to a GOA unit of a first row of gate lines of an even-numbered group of gate lines.

4. The GOA circuit according to claim 3, wherein
in two adjacent odd-numbered groups of gate lines, the first gating sub-unit is configured to trigger a GOA unit corresponding to a first row of gate lines of a next odd-numbered group of gate lines to output a scanning signal after it is detected that a GOA unit corresponding to a last row of gate lines of a previous odd-numbered group of gate lines outputs a scanning signal; and
in two adjacent even-numbered groups of gate lines, the second gating sub-unit is configured to trigger a GOA unit corresponding to a first row of gate lines of a next even-numbered group of gate lines to output a scanning signal after it is detected that a GOA unit corresponding to a last row of gate lines of a previous even-numbered group of gate lines outputs a scanning signal.

5. A scanning method of the GOA circuit according to claim 1, comprising:
controlling the GOA circuit to output a scanning signal from a first group to a k-th group of gate lines sequentially; and
in a x-th group, outputting a scanning signal from a x-th row to a (m×k+x)-th row sequentially by the GOA circuit.

6. The method according to claim 5, wherein the controlling the GOA circuit to output a scanning signal from a first group to a k-th group of gate lines sequentially comprises:
in two adjacent groups of gate lines, triggering a GOA unit corresponding to a first row of gate lines of a next group of gate lines to output a scanning signal after it is detected that a GOA unit corresponding to a last row of gate lines of a previous group of gate lines output a scanning signal.

7. The method according to claim 5, wherein the controlling the GOA circuit to output a scanning signal from a first group to a k-th group of gate lines sequentially comprises:
in two adjacent odd-numbered groups of gate lines, triggering a GOA unit corresponding to a first row of gate lines of a next odd-numbered group of gate lines to output a scanning signal after it is detected that a GOA unit corresponding to a last row of gate lines of a previous odd-numbered group of gate lines outputs a scanning signal; and
in two adjacent even-numbered groups of gate lines, triggering a GOA unit corresponding to a first row of gate lines of a next even-numbered group of gate lines to output a scanning signal after it is detected that a GOA unit corresponding to a last row of gate lines of a previous even-numbered group of gate lines outputs a scanning signal.

8. A display panel, comprising the GOA circuit according to claim 1.

9. A display device, comprising the display panel according to claim 8.

10. The GOA circuit according to claim 2, wherein the gating unit comprises a first gating sub-unit and a second gating sub-unit;
the first gating sub-unit is connected to a GOA unit of a first row of gate lines of an odd-numbered group of gate lines; and
the second gating sub-unit is connected to a GOA unit of a first row of gate lines of an even-numbered group of gate lines.

11. The method according to claim 5, wherein
in two adjacent groups of gate lines, the gating unit is configured to trigger a GOA unit corresponding to a first row of gate lines of a next group of gate lines to output a scanning signal after it is detected that a GOA unit corresponding to a last row of gate lines of a previous group of gate lines outputs a scanning signal.

12. The method according to claim 5, wherein the gating unit comprises a first gating sub-unit and a second gating sub-unit;
the first gating sub-unit is connected to a GOA unit of a first row of gate lines of an odd-numbered group of gate lines; and
the second gating sub-unit is connected to a GOA unit of a first row of gate lines of an even-numbered group of gate lines.

13. The method according to claim 12, wherein
in two adjacent odd-numbered groups of gate lines, the first gating sub-unit is configured to trigger a GOA unit corresponding to a first row of gate lines of a next odd-numbered group of gate lines to output a scanning signal after it is detected that a GOA unit corresponding to a last row of gate lines of a previous odd-numbered group of gate lines outputs a scanning signal; and
in two adjacent even-numbered groups of gate lines, the second gating sub-unit is configured to trigger a GOA unit corresponding to a first row of gate lines of a next even-numbered group of gate lines to output a scanning signal after it is detected that a GOA unit corresponding to a last row of gate lines of a previous even-numbered group of gate lines outputs a scanning signal.

14. The display panel according to claim 8, wherein
in two adjacent groups of gate lines, the gating unit is configured to trigger a GOA unit corresponding to a first row of gate lines of a next group of gate lines to output a scanning signal after it is detected that a GOA unit corresponding to a last row of gate lines of a previous group of gate lines outputs a scanning signal.

15. The display panel according to claim 8, wherein the gating unit comprises a first gating sub-unit and a second gating sub-unit;
the first gating sub-unit is connected to a GOA unit of a first row of gate lines of an odd-numbered group of gate lines; and
the second gating sub-unit is connected to a GOA unit of a first row of gate lines of an even-numbered group of gate lines.

16. The display panel according to claim 15, wherein
in two adjacent odd-numbered groups of gate lines, the first gating sub-unit is configured to trigger a GOA unit corresponding to a first row of gate lines of a next odd-numbered group of gate lines to output a scanning signal after it is detected that a GOA unit corresponding to a last row of gate lines of a previous odd-numbered group of gate lines outputs a scanning signal; and
in two adjacent even-numbered groups of gate lines, the second gating sub-unit is configured to trigger a GOA unit corresponding to a first row of gate lines of a next even-numbered group of gate lines to output a scanning signal after it is detected that a GOA unit corresponding to a last row of gate lines of a previous even-numbered group of gate lines outputs a scanning signal.
